(19) United States
(12) Patent Application Publication
(10) Pub. No.: US 2025/0242609 A1
(43) Pub. Date: Jul. 31, 2025

(54) PRINTER AND PLATEN MODULE

(71) Applicant: Toshiba Tec Kabushiki Kaisha, Tokyo (JP)

(72) Inventors: Eugene CHAN, Singapore (SG); Kenji EOKA, Sunto Shizuoka (JP)

(21) Appl. No.: 18/924,946

(22) Filed: Oct. 23, 2024

(30) Foreign Application Priority Data
Jan. 26, 2024 (JP) 2024-010136

(51) Int. Cl. B41J 11/04; B41J 3/407; B41J 11/70; B41J 15/04

(52) U.S. Cl. CPC B41J 11/04; B41J 3/4075; B41J 11/703; B41J 15/046

(57) ABSTRACT

A printer for printing on a rolled sheet includes a housing having an opening through which the sheet is installed, a lid rotatable to cover the opening, a platen module detachably attached to the lid and including a roller for conveying the sheet, a print head attached to the housing to face the roller and configured to print an image on the sheet, and a first blade attached to the lid and by which a part of the sheet is cut. The platen module further includes a guide member that guides the sheet conveyed from the roller towards the first blade and at least partially covers a side surface of the first blade.

### CROSS-REFERENCE TO RELATED APPLICATION(S)

This application is based upon and claims the benefit of priority from Japanese Patent Application No. 2024-010136, filed Jan. 26, 2024, the entire contents of which are incorporated herein by reference.

### FIELD

Embodiments described herein relate generally to a printer and a platen module.

### BACKGROUND

Conventionally, in printers for printing on a rolled sheet with a belt-like sheet wound thereon, a platen roller is detachably provided on a frame, and when a cutter for cutting the sheet is cleaned, the blade is moved and exposed from its storage slit or the like. Such configurations make it easy to replace the platen roller and clean the cutter.

Examples of the sheet include a receipt sheet, a label sheet, and a label without a mount sheet. The receipt sheet is a non-stick sheet used for a receipt or the like. The label sheet is formed by attaching labels having a predetermined size on a strip-shaped mount sheet. The labels have a glue layer (or an adhesive layer) on the back surface of a printing surface. The label without a mount sheet has a glue layer on the back surface of a belt-shaped sheet.

The label without a mount sheet has been widely used in recent years. At the time of issuance, a part of the label is cut by a cutter unit of a printer. In such a case, since the glue of the label adheres to the cutter unit and the platen roller and the sheet guide member around them, periodic cleaning and replacement are required.

However, in the conventional configuration, the platen roller can be removed and cleaned or replaced, but the cleaning of the sheet guide member and the movable blade around the platen roller requires another operation, which is complicated. In addition, because cleaning of the movable blade is performed by moving and exposing the movable blade from the storage slit, it is dangerous and not preferable.

### SUMMARY OF THE INVENTION

Embodiments of the present invention provide a printer and a platen module capable of improving maintainability of a platen roller and its surroundings and a cutter unit.

In one embodiment, a printer for printing on a rolled sheet, comprises: a housing having an opening through which the sheet is installed; a lid rotatable to cover the opening; a platen module detachably attached to the lid and including a roller for conveying the sheet; a print head attached to the housing to face the roller and configured to print an image on the sheet; and a first blade attached to the lid and by which a part of the sheet is cut. The platen module further includes a guide member that guides the sheet conveyed from the roller towards the first blade and at least partially covers a side surface of the first blade.

### BRIEF DESCRIPTION OF THE DRAWINGS

FIG. 1 is a perspective view illustrating an external appearance of a printer according to an embodiment.

FIG. 2 is a cross-sectional view illustrating an internal structure of the printer.

FIG. 3 is a cross-sectional view illustrating the printer in a state where a lid portion is opened.

FIG. 4 is a perspective view illustrating the printer in a state where the lid portion is opened.

FIG. 5 is a perspective view of a state in which a platen module is removed from the lid portion.

FIG. 6 is a perspective view of the platen module removed from the lid potion.

FIG. 7 is a perspective view of the lid portion with the platen module removed.

### DETAILED DESCRIPTION

### First Embodiment

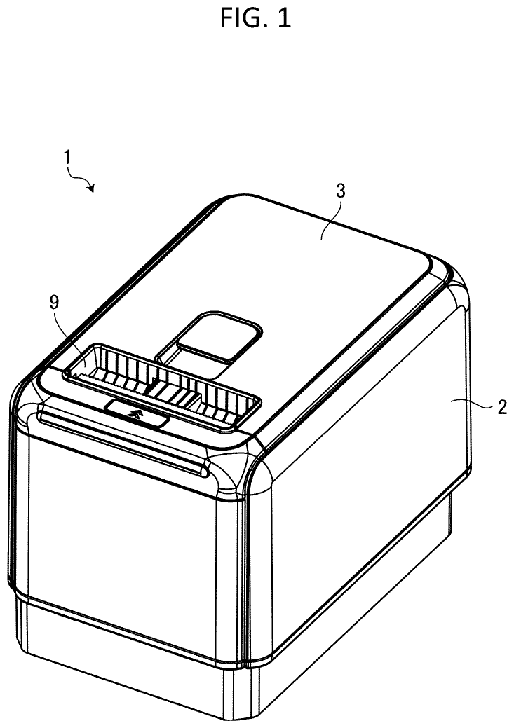

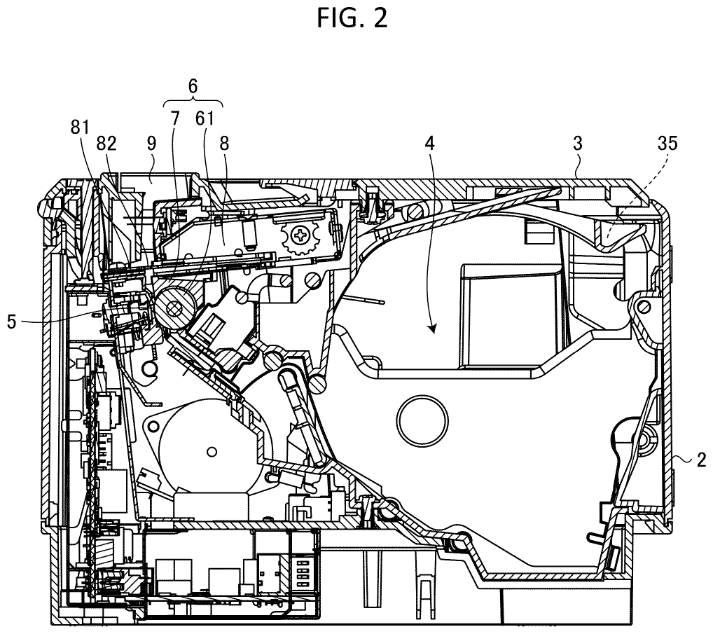

Embodiments will be described with reference to the drawings. FIG. 1 is a perspective view illustrating an external appearance of a printer 1 according to a first embodiment. The perspective view of FIG. 1 shows the front and right sides of the printer 1 visible and the left and back sides of the printer 1 invisible. FIG. 2 is a cross-sectional view illustrating an internal structure of the printer 1. The printer 1 includes a housing 2, a lid 3, a sheet holder 4, a print head 5, a platen module 6, a cutter 8, and the like. The platen module 6 includes a platen roller 61 and a guide member 7.

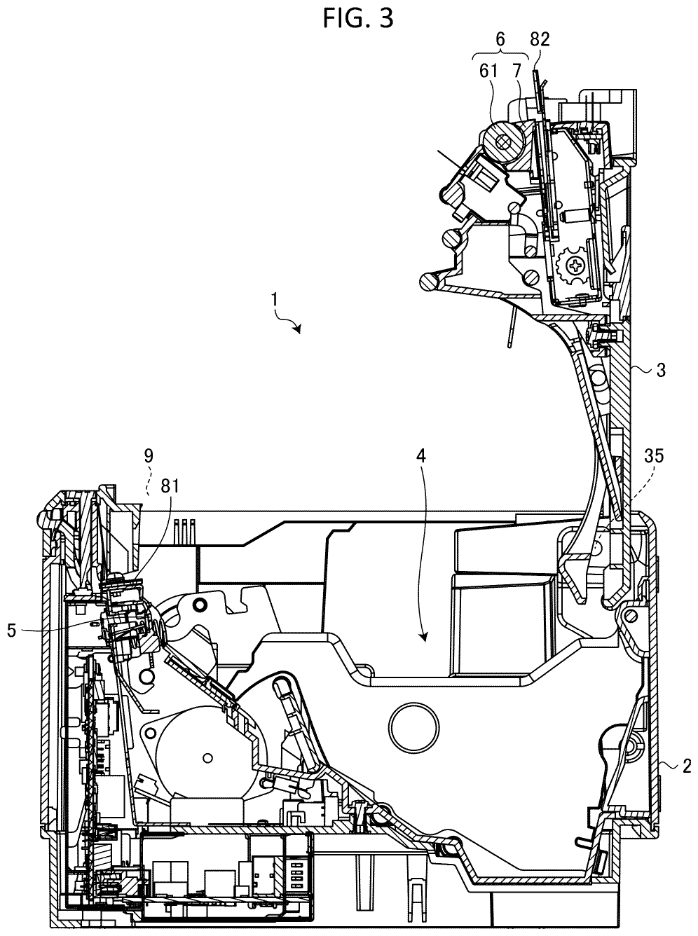

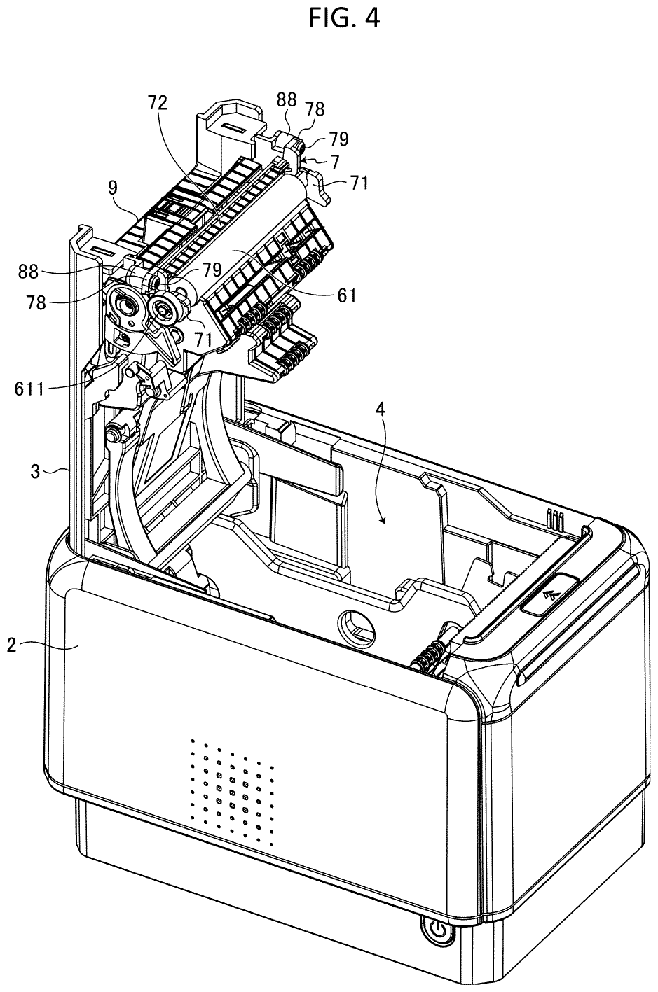

FIG. 3 is a cross-sectional view showing the printer 1 in a state where the lid 3 is opened. FIG. 4 is a perspective view illustrating the printer 1 in a state where the lid 3 is opened.

The housing 2 is a chassis having an opening that can be covered by the lid 3. The lid 3 is rotatably attached to one end of the opening of the housing 2 about a shaft 35 provided at one end, and moves between a closed position in which the opening of the housing 2 is covered and an open position in which the opening is not covered in accordance with the rotation. A sheet discharge port 9 is formed between the free end of the lid 3 at the closed position and the housing 2.

The sheet holder 4 holds the rolled sheet while maintaining the position in the width direction thereof. The rolled sheet is formed by winding a belt-shaped sheet. The sheet is a general sheet such as a receipt sheet, a label having a predetermined size attached to a strip-shaped mount sheet, a strip-shaped label without a mount sheet, or the like. Note that the label has a glue layer on one side of the sheet (e.g., the back side of the printing surface). The sheet may be a paper sheet, a plastic film or the like.

The print head 5 prints on a sheet sandwiched between itself and the platen roller 61, and is, for example, a line thermal head in which a plurality of heating elements are arranged along the sheet width direction. The platen roller 61 is a cylindrical roller having elasticity on its surface, and is rotationally driven around a shaft 611 to convey a sheet sandwiched between itself and the print head 5.

The print head 5 is provided in the housing 2, the platen roller 61 is attached to the lid 3, and the print head 5 and the platen roller 61 can come into contact with and separate from each other in accordance with the rotation movement of the lid 3. When the print head 5 and the platen roller 61 are separated from each other, the sheet conveyance path is opened.

The cutter 8 is attached to the lid 3, is provided on the downstream side in the sheet conveying direction from the print head 5 and the platen roller 61, and cuts the sheet after printing.

The cutter 8 includes, for example, a fixed blade 81 and a movable blade 82. The fixed blade 81 and the movable blade 82 are arranged such that the cutting edges face each other and sandwich the sheet conveyance path in the sheet thickness direction. The fixed blade 81 is fixed in the housing 2. The movable blade 82 is attached to the lid 3 and moves in a direction of coming into contact with and separating from the fixed blade 81 by receiving a driving force. When the cutting edge of the movable blade 82 slides with the cutting edge of the fixed blade 81, the sheet sandwiched therebetween is cut.

In the printer 1 having such a configuration, the lid 3 is opened, the rolled sheet is held by the sheet holder 4 in the housing 2, and the sheet drawn out from the rolled sheet is positioned so as to be sandwiched between the print head 5 and the platen roller 61, and the lid 3 is closed. As a result, the printer 1 is in an operable state, that is, a printable state.

The printer 1 in operation drives the platen roller 61 to rotate, thereby driving the print head 5 to perform printing on the sheet while conveying the sheet sandwiched between the platen roller 61 and the print head 5. The printer 1 also controls the cutter 8 so that the sheet is cut at an appropriate position. More specifically, drive control for moving the movable blade 82 is performed.

When the sheet is a label without a mount sheet, the printer 1 waits for the cut sheet to be removed from the sheet discharge port 9 every time the cutter 8 cuts the sheet, and performs the next printing after the cut sheet is removed. For this control, the printer 1 includes a sensor for detecting the presence or absence of a sheet in the sheet discharge port 9. In the printer 1 for printing on the label without the mount sheet, printing is possible when the sensor does not detect the sheet.

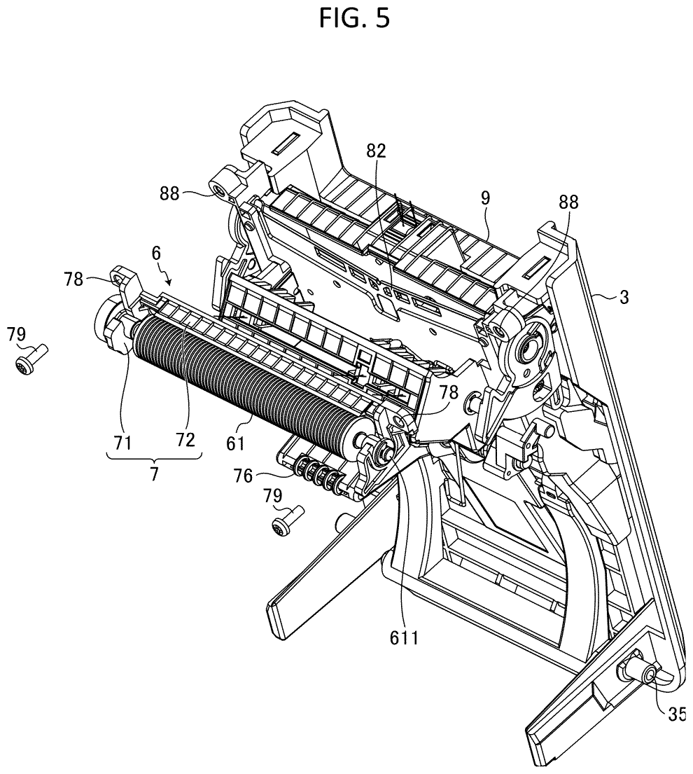

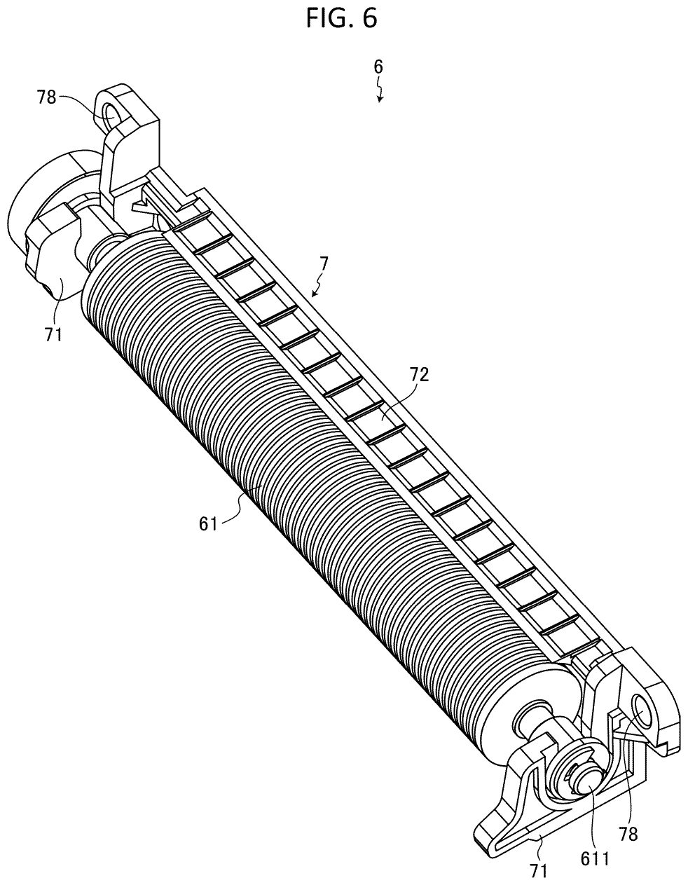

FIG. 5 is a perspective view of the platen module 6 removed from the lid 3. FIG. 6 is a perspective view of the platen module 6 removed from the lid 3. The platen roller 61 and the guide member 7 constitute the platen module 6 in one embodiment.

The guide member 7 includes a support unit 71 and a guide unit 72, and is detachable from a position covering the movable blade 82 located away from the fixed blade 81 (i.e., in a retracted state without being exposed to the sheet conveyance path). The support unit 71 is provided at both end portions of the guide unit 72, and rotatably supports both end portions of the shaft 611 of the platen roller 61 by a substantially U-shaped concave portion. The guide unit 72 is provided at a position that fills the gap between the cutter 8 and the platen roller 61 along the longitudinal direction of the platen roller 61 to prevent the sheet from entering the gap and to guide the sheet.

The platen module 6 is attached to the inner surface of the lid 3 by a screw 79, and is detachable from the lid 3. The screw 79 passes through a mounting hole 78 formed in each of the support unit 71 of the guide member 7, and is screwed into a screw hole 88 formed in the cutter 8.

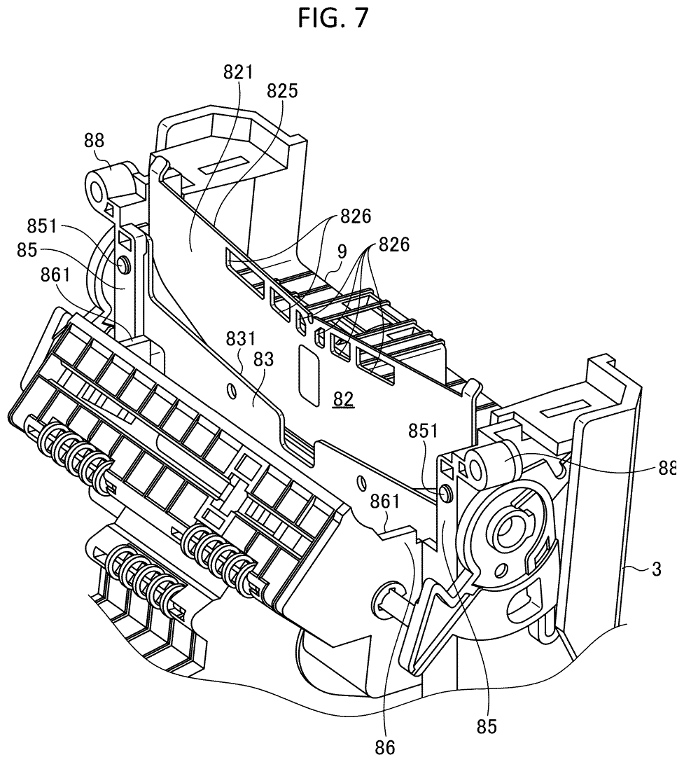

The platen module 6 attached to the lid 3 covers at least a portion of the cutter 8. Here, FIG. 7 is a perspective view of the lid 3 from which the platen module 6 is removed. The covered portion is specifically within a predetermined range of a surface 821 of the movable blade 82, including the cutting blade 825.

Note that the movable blade 82 illustrated in FIG. 7 is at a position protruding from a slit 831 of a storage cover 83. The cutter 8 further includes a storage cover 83, a first bracket 85, and a second bracket 86.

The storage cover 83 houses the movable blade 82 so that the cutting blade 825 of the movable blade 82 can be taken in and out freely. The storage cover 83 surrounds the movable blade 82 and protects the movable blade 82 from unexpected damage and the like, and secures a moving range of the movable blade 82. During the cutting operation, the movable blade 82 enters and exits the slit 831. The storage cover 83 has a shape that exposes a predetermined range including the cutting blade 825 of the accommodated movable blade 82.

The first bracket 85 holds both side portions of the storage cover 83. The second bracket 86 holds both ends of the platen module 6 by a concave portion 861 formed between the second bracket and the first bracket 85.

Further, the first bracket 85 has, on the surface of the second bracket 86 side, an uneven shape for positioning to attach the platen module 6 to the correct position (a convex portion 851 in the present embodiment). The guide member 7 has an uneven shape for positioning at a position facing the convex portion 851 (a concave portion in the embodiment). When the concave portion of the guide member 7 is fitted into the convex portion 851 of the first bracket 85, the platen module 6 is positioned at an accurate position with respect to the print head 5 via the first bracket 85, the lid 3, and the housing 2. That is, the platen roller 61 is positioned by fitting the uneven shape of the guide member 7 and the first bracket 85 on the contact surface with each other (i.e., the convex portion 851 and the concave portion facing the convex portion).

Incidentally, FIG. 7 is shown for the purpose of explanation, the movable blade 82, other than during the cutting operation, in the position shown in FIG. 5 or the like. That is, the movable blade 82 which is not in the cutting operation is exposed through the slit 831 of the storage cover 83 a predetermined range including the cutting blade 825, does not protrude the cutting blade 825 from the guide unit 72.

The platen module 6 also serves as a member that covers the surface 821 of the movable blade 82 included in the cutter 8 on the platen roller 61 side. Therefore, the surface 821 of the movable blade 82 is exposed by removing the platen module 6 from the lid 3.

A plurality of holes 826 are formed along the cutting blade 825 in the vicinity of the cutting blade 825 of the movable blade 82. The position where the holes 826 are formed is included in a predetermined range including the cutting blade 825 described above.

In the holes 826, when the sheet is a label without a mount sheet, the glue transferred from the glue layer on the back surface of the printing surface to the movable blade 82 is moved by sliding of the movable blade 82 and the sheet, and is accumulated. When the holes 826 are not provided, the glue transferred to the movable blade 82 remains on the surface 821 or the like and accumulates together with sheet dust or the like, which causes a defect. The holes 826 reduce the volume of glue, sheet dust, and the like, and prevent the occurrence of defects.

Conventionally, not only a movable blade and a fixed blade but a platen roller and a guide unit have a coating to prevent a glue from being attached thereto. However, such a coating has not been able to eliminate the adherence of the glue completely. Therefore, cleaning of the movable blade and cleaning or replacement the platen roller and the guide unit of the cutter have been inevitable. For example, the cleaning of the movable blade is performed by disassembling the cutter or positioning the movable blade at the protruding position at the time of cutting, the former is complicated, and the latter is dangerous.

In contrast, in the present application, when the platen module 6 is removed from the lid 3 by removing the screw 79, the surface 821 is exposed. As a result, the surface 821, the cutting blade 825, and the hole 826 can be easily cleaned, and the glue, sheet dust, and the like adhering to the movable blade 82 can be more easily removed than in the related art.

Further, when the surface and the guide unit 72 of the platen roller 61 is contaminated with glue, sheet dust, or the like, the platen module 6 may be removed, and the platen roller 61 and the guide member 7 may be separately cleaned, but by replacing the platen module 6, it is possible to eliminate the need for cleaning. Since the platen roller 61 is also a consumable, it is possible to eliminate the need for cleaning the platen roller 61 and the guide unit 72 by replacing the platen module 6 at a timing determined based on the state of wear.

As described above, according to the present embodiment, it is possible to improve the maintainability around the platen roller 61 and the cutter 8 of the printer 1. In other words, it is possible to reduce the number of troubles required for maintenance and to facilitate maintenance.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer for printing on a rolled sheet, comprising:
a housing having an opening through which the sheet is installed;
a lid rotatable to cover the opening;
a platen module detachably attached to the lid and including a roller for conveying the sheet;
a print head attached to the housing to face the roller and configured to print an image on the sheet; and
a first blade attached to the lid and by which a part of the sheet is cut, wherein
the platen module further includes a guide member that guides the sheet conveyed from the roller towards the first blade and at least partially covers a side surface of the first blade.

2. The printer according to claim 1, wherein the guide member includes a guide unit that extends between the roller and the first blade along a rotation axis of the roller.

3. The printer according to claim 2, wherein the guide member includes a support unit that is connected to the guide unit and rotatably supports the roller.

4. The printer according to claim 1, wherein the guide member covers the side surface of the first blade including a cutting edge thereof.

5. The printer according to claim 1, further comprising:
a storage cover attached to the lid and in which the first blade is stored; and
a bracket that holds ends of the storage cover.

6. The printer according to claim 5, wherein an upper part of the first blade is exposed through the storage cover.

7. The printer according to claim 5, wherein the guide member is connectable to the bracket.

8. The printer according to claim 7, wherein a surface of the guide member is engageable with a surface of the bracket.

9. The printer according to claim 1, further comprising:
a second blade attached to the housing to face the first blade and by which a part of the sheet is cut.

10. The printer according to claim 9, wherein
the first blade is moveable along a direction perpendicular to a sheet conveyance direction and includes one or more openings along a cutting edge of the first blade, and
the second blade is fixed to the housing.

11. A platen module attachable to a lid of a printer capable of printing on a rolled sheet, the printer including a first blade attached to the lid to cut the sheet, the platen module comprising:
a roller for conveying the sheet; and
a guide member that guides the sheet conveyed from the roller towards the first blade and at least partially covers a side surface of the first blade when the platen module is attached to the lid of the printer.

12. The platen module according to claim 11, wherein the guide member includes a guide unit that extends between the roller and the first blade along a rotation axis of the roller.

13. The platen module according to claim 12, wherein the guide member includes a support unit that is connected to the guide unit and rotatably supports the roller.

14. The platen module according to claim 11, wherein the guide member covers the side surface of the first blade including a cutting edge thereof.

15. The platen module according to claim 11, wherein the first blade is stored in a storage cover that is attached to the lid via a bracket.

16. The platen module according to claim 15, wherein an upper part of the first blade is exposed through the storage cover.

17. The platen module according to claim 15, wherein the guide member is connectable to the bracket.

18. The platen module according to claim 17, wherein a surface of the guide member is engageable with a surface of the bracket.

19. The platen module according to claim 11, wherein
the guide member has a mounting hole, and
the platen module is attachable to a cutter unit including the first blade using a screw through the mounting hole.

20. The platen module according to claim 11, wherein the platen module is attached to a free end of the lid that is rotatable to close an opening of a housing of the printer.
